(19) United States
(12) Patent Application Publication
(10) Pub. No.: US 2019/0061629 A1
(43) Pub. Date: Feb. 28, 2019

(54) SAFETY LADDER AND RETAINING SYSTEM FOR TRAILER

(71) Applicant: NORCAN ALUMINIUM INC., Boucherville (CA)

(72) Inventors: Ghyslain GEMME, St-Amable (CA); Albert CHARTIER, Chertsey (CA)

(21) Appl. No.: 15/687,023

(22) Filed: Aug. 25, 2017

(51) Int. Cl. B60R 3/00; E06C 7/18; A62B 35/00

(52) U.S. Cl. CPC B60R 3/005; A62B 35/0056; E06C 7/182

(57) ABSTRACT

A climbing apparatus for safely climbing on a roof of a trailer, the climbing apparatus comprising a ladder portion, a upper pivot portion for pivoting an upper portion of the ladder portion, the upper pivot portion being secured to the trailer to allow movements of the ladder portion between a work configuration and a stored configuration next to a wall of the trailer and a movable support adapted to maintain the ladder portion in the work configuration by providing increased angle between the ladder portion and the wall of the trailer.

### TECHNICAL FIELD

The present invention relates to a ladder mechanism for accessing a roof of a trailer.

### BACKGROUND

Trailers are used to transport cargo and can be significantly large. Trailers can be used in all sorts of conditions and weather. For instance, trailers that are used in winter conditions are going to receive and collect snow on their roof. That snow on the roof should be removed before the trailer is pulled on the road to prevent snow to become airborne with the aerodynamics of the vehicle and becomes a hazard for other vehicles following the trailer. The situation can become critical if there is ice on top of the trailer that could become airborne and hit other vehicles.

Removing ice and snow from the roof of the trailer before moving the trailer on road is hence required. Someone should climb on the trailer's roof to shovel undesirable material, snow and ice in the present example. A ladder must generally be used to access the roof of the trailer that is impossible to reach for a human. A standard ladder can be used and removed after use. This option is possible if there is a ladder available because transporting a ladder is a cumbersome option. Using a distinct standard ladder can represent a danger should the ladder slip on ice or on trailer's side. In other configurations, a ladder can be secured directly on the trailer to be used as a means for climbing on the trailer. The latter configuration is generally not ergonomical and unadaptable to match various configurations.

Water, snow and ice are considerably reducing friction on the roof of the trailer. The surface of the trailer's roof hence become more slippery for a user having to work on it to clear off snow and ice.

Accordingly, there is a need for an improved trailer-climbing apparatus over the existing art. A need has also been felt for a trailer-climbing apparatus that is more ergonomical and safer to use. A further need has been felt for a trailer-climbing apparatus that can be easily installed and economically manufactured.

### BRIEF SUMMARY

It is one aspect of the present invention to alleviate one or more of the drawbacks of the background art by addressing one or more of the existing needs in the art. Accordingly, embodiments of this invention provide an improved safety ladder and retaining system for trailer over the existing art.

The present invention, in accordance with at least one embodiment thereof, provides a trailer-climbing apparatus that can be secured to a trailer and adjusted between a stored configuration and a work configuration. The trailer-climbing apparatus is also designed to offer a support to a user while moving on the roof of the trailer. The trailer-climbing apparatus can also cooperate with a retaining line disposed on the trailer to prevent a fall from the trailer.

The present invention, in accordance with at least one embodiment thereof, provides a trailer-climbing apparatus that can be disposed at an angle from a wall of the trailer.

The present invention, in accordance with at least one embodiment thereof, provides a trailer-climbing apparatus that includes an extendable portion providing additional support to a user on the roof level of the trailer.

The present invention, in accordance with at least one embodiment thereof, provides a trailer-climbing apparatus that is connected to a pair of retaining elements disposed in a longitudinal direction of the trailer to secure a user on the roof by limiting lateral movements of the user away from side edges of the trailer's roof.

The present invention, in accordance with at least one embodiment thereof, provides a trailer-climbing apparatus that is made of light and corrosion-resistant material.

Other embodiments and further scope of applicability of the present invention will become apparent from the detailed description given hereinafter. However, it should be understood the detailed description and specific examples, while indicating preferred embodiments of the invention, are given by way of illustration only, since various changes and modifications within the spirit and scope of the invention will become apparent to those skilled in the art from this detailed description.

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

These and other features of that described herein will become more apparent from the following description in which reference is made to the appended drawings herein:

FIG. 1 is illustrating, in accordance with at least one embodiment of the invention, an isometric view of a climbing apparatus on a trailer;

FIG. 2 is illustrating, in accordance with at least one embodiment of the invention, an isometric view of the climbing apparatus;

FIG. 3 is illustrating, in accordance with at least one embodiment of the invention, an isometric partial view of the climbing apparatus;

FIG. 4 is illustrating, in accordance with at least one embodiment of the invention, an isometric partial view of the climbing apparatus;

FIG. 5 is illustrating, in accordance with at least one embodiment of the invention, an isometric view of the climbing apparatus;

FIG. 6 is illustrating, in accordance with at least one embodiment of the invention, an isometric view of the climbing apparatus;

FIG. 7 is illustrating, in accordance with at least one embodiment of the invention, a left elevation side view of the climbing apparatus in a stored configuration;

FIG. 8 is illustrating, in accordance with at least one embodiment of the invention, a left elevation side view of the climbing apparatus in a work configuration;

FIG. 9 is illustrating, in accordance with at least one embodiment of the invention, a left elevation side view of the climbing apparatus in a work configuration;

FIG. 10 is illustrating, in accordance with at least one embodiment of the invention, a partial left elevation side view of the climbing apparatus in a work configuration;

FIG. 11 is illustrating, in accordance with at least one embodiment of the invention, a front elevation view of the climbing apparatus in the work configuration;

FIG. 12 is illustrating, in accordance with at least one embodiment of the invention, a front-right perspective view of the climbing apparatus in a work configuration;

FIG. 13 is illustrating, in accordance with at least one embodiment of the invention, a portion of a retaining mechanism;

FIG. 14 is illustrating, in accordance with at least one embodiment of the invention, a partial left elevation side view of the climbing apparatus in the work configuration;

FIG. 15 is illustrating, in accordance with at least one embodiment of the invention, an isometric view of a portion of the climbing apparatus;

FIG. 16 is illustrating, in accordance with at least one embodiment of the invention, an isometric view of a portion of the climbing apparatus;

FIG. 17 is illustrating, in accordance with at least one embodiment of the invention, an isometric view of a portion of the climbing apparatus;

FIG. 18 is illustrating, in accordance with at least one embodiment of the invention, an isometric view of a portion of the climbing apparatus;

FIG. 19 is illustrating, in accordance with at least one embodiment of the invention, an isometric view of a portion of the climbing apparatus;

FIG. 20 is illustrating, in accordance with at least one embodiment of the invention, an isometric view of the climbing apparatus;

FIG. 21 is illustrating, in accordance with at least one embodiment of the invention, a top plan view of the climbing apparatus;

FIG. 22 is illustrating, in accordance with at least one embodiment of the invention, an isometric view of a portion of the climbing apparatus;

FIG. 23 is illustrating, in accordance with at least one embodiment of the invention, an isometric view of a portion of the climbing apparatus;

FIG. 24 is illustrating, in accordance with at least one embodiment of the invention, an isometric view of a portion of the climbing apparatus; and

FIG. 25 is illustrating, in accordance with at least one embodiment of the invention, an isometric view of a portion of the climbing apparatus.

### DETAILED DESCRIPTION

Preferred embodiments of the present invention are described below with reference to the drawings. The invention can be implemented in numerous ways, including as an apparatus and a kit thereof. In this specification, these implementations, or any other form that the invention may take, may be referred to as embodiments and techniques. A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

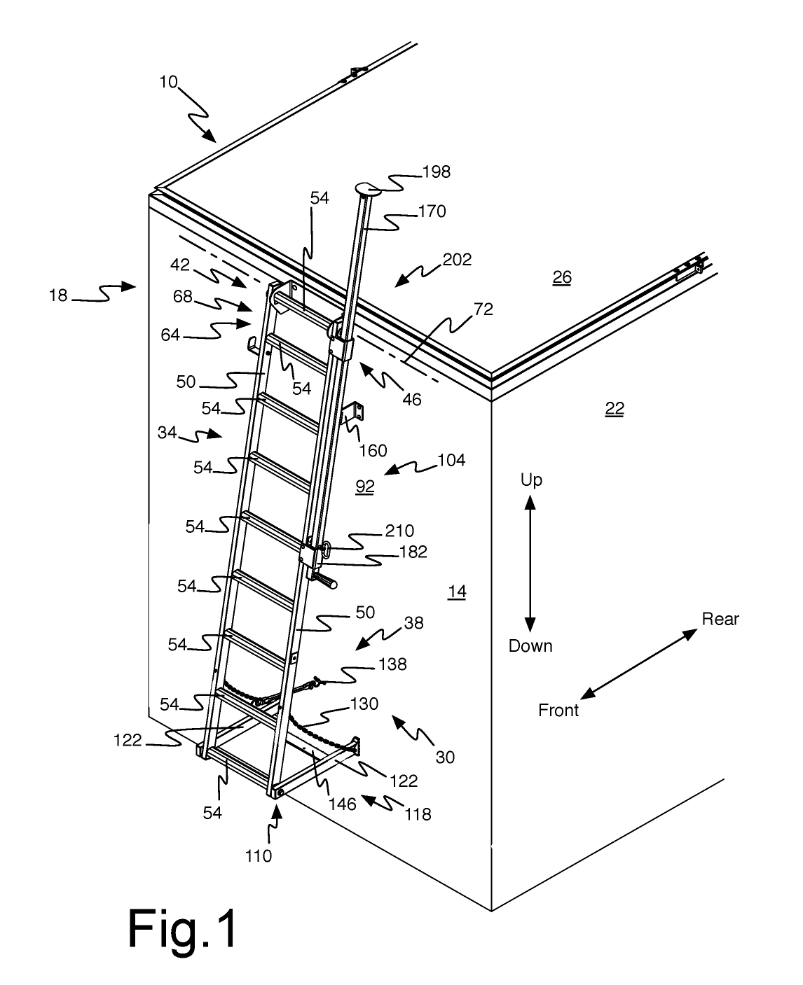

A trailer 10 is illustrated in FIG. 1. The trailer 10 includes a front portion 14, a right portion 18, a left portion 22 and a top portion 26 thereof. The trailer 10 is equipped with an embodiment of a climbing apparatus 30 for accessing the top portion 26. The climbing apparatus 30 is installed on the front portion 14 of the trailer 10 in FIG. 1. The climbing apparatus 30 could be installed on another portion of the trailer 10, if desirable, without departing from the scope of the present application. The climbing apparatus 30 is preferably secured on the front portion 14 of the trailer 10, as illustrated in FIG. 1, to be located and housed between the trailer 10 and a pulling tractor vehicle (not illustrated) hence preventing increasing the lateral trailer's 10 dimension. The climbing apparatus 30 includes a ladder portion 34, a lower pivot portion 38, a upper pivot portion 42 and an extendable portion 46.

The ladder portion 34 is generally sized and designed to efficiently allow a user to climb on the trailer 10 when desired. The ladder portion 34, as embodied, includes a pair of vertical members 50 interconnecting a plurality of step members 54 that are ideally equidistantly disposed from one another. The vertical members 50 and step members 54 are made of a material having sufficiently mechanically strong properties. Corrosion resistance and light weight are also desirable considering the purpose of the climbing apparatus 30 installed on a vehicle. The climbing apparatus 30 of the illustrated embodiment is using aluminum material. Other suitable materials could be used and remain within the scope of the present application.

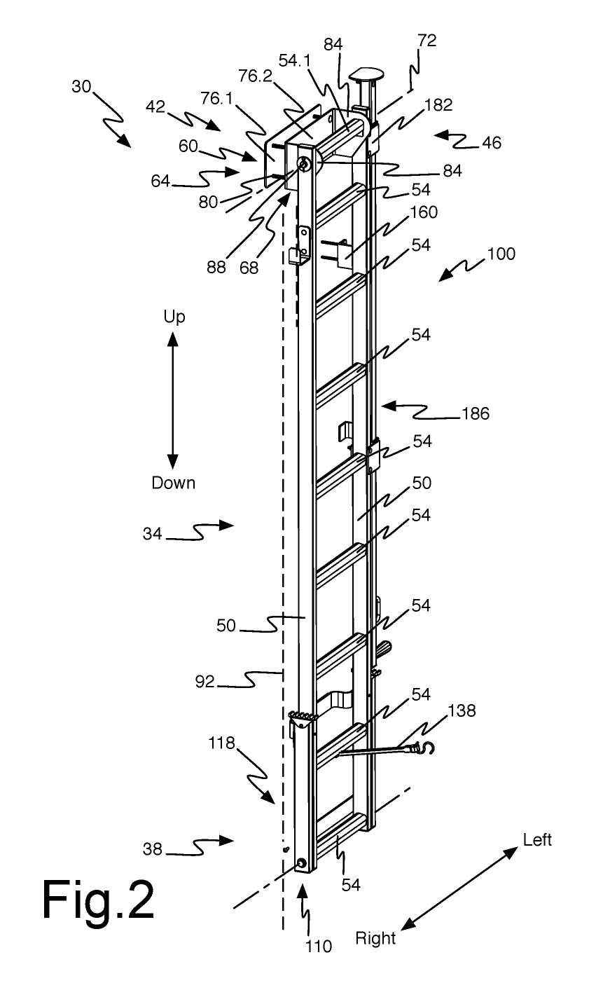

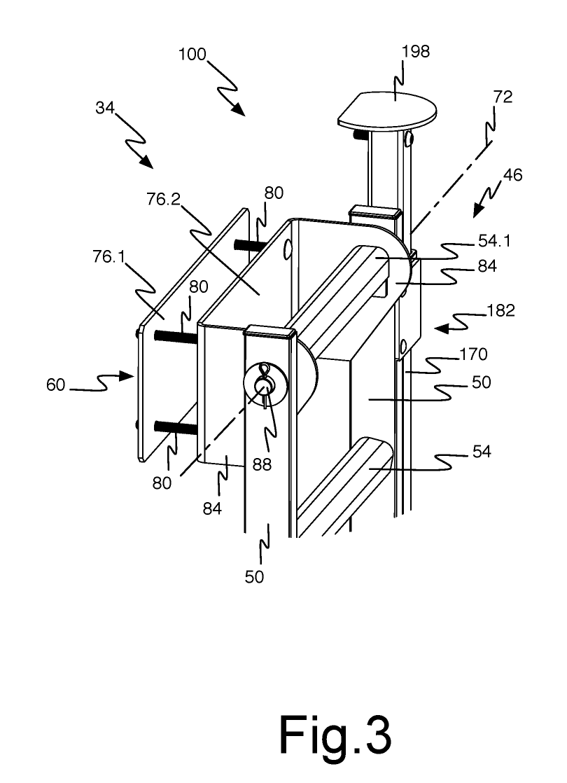

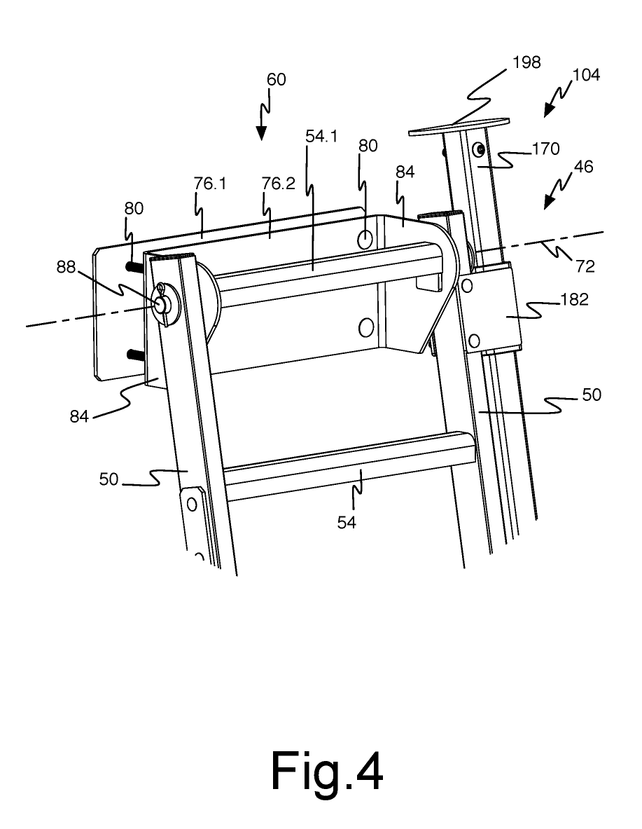

The upper pivot portion 42 of the climbing apparatus 30 includes a bracket 60 designed to be secured on an upper portion of the trailer 10. The upper pivot portion 42 provides a pivot 64 to an upper end 68 of the ladder portion 34 for pivoting the climbing apparatus 30 about a pivot axis 72. The bracket 60, as best seen in FIG. 2, FIG. 3 and FIG. 4, is embodied with two opposed plate members 76 interconnected with a series of fasteners 80. One plate member 76.1 is adapted to be located inside the trailer 10 and the other plate member 76.2 on the outside of the trailer 10. The fasteners 80 are securing both plate members 76 on the trailer's wall by passing through the wall (not illustrated in FIG. 2) and sandwiching the trailer's wall therebetween. The pivot 64 is embedded in the other plate member 76.2 with a pair of lateral extensions 84 extending therefrom. Openings in the lateral extensions 84 are sized and designed to receive a pivot axle 88 that is engaging the vertical members 50 as well as to allow the ladder portion 34 to pivot. The pivot axle 88 is also passing inside a step member 54.1 for ease of use and improved aesthetic appearance.

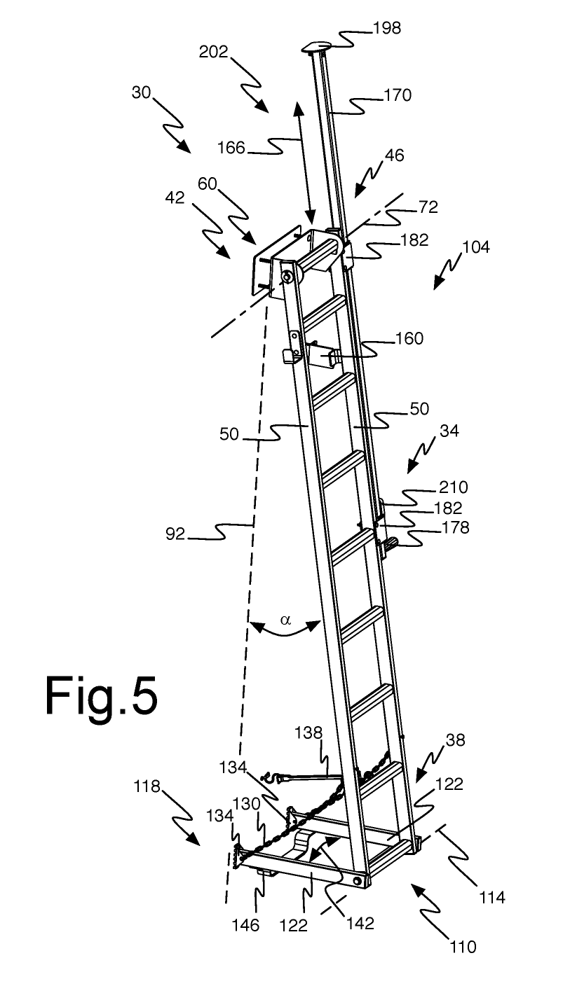

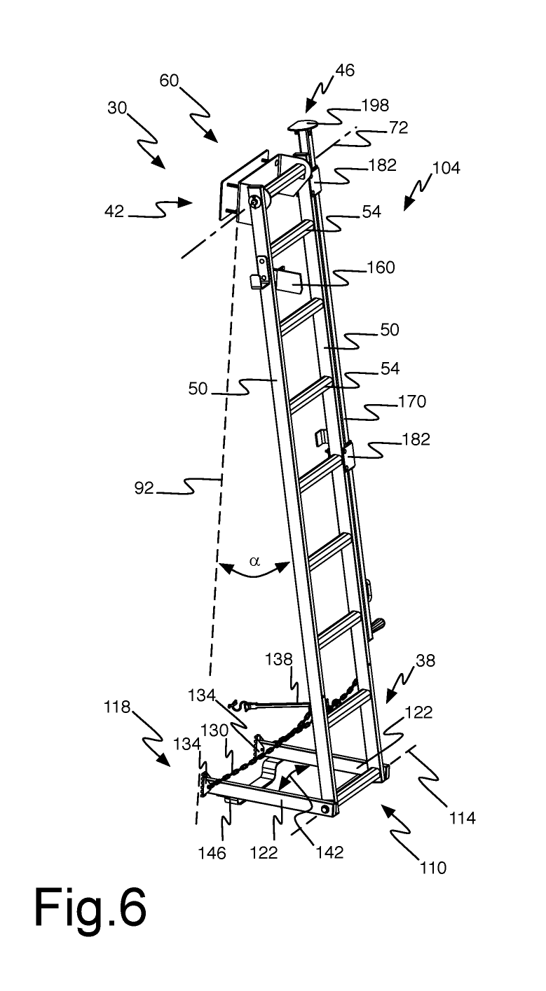

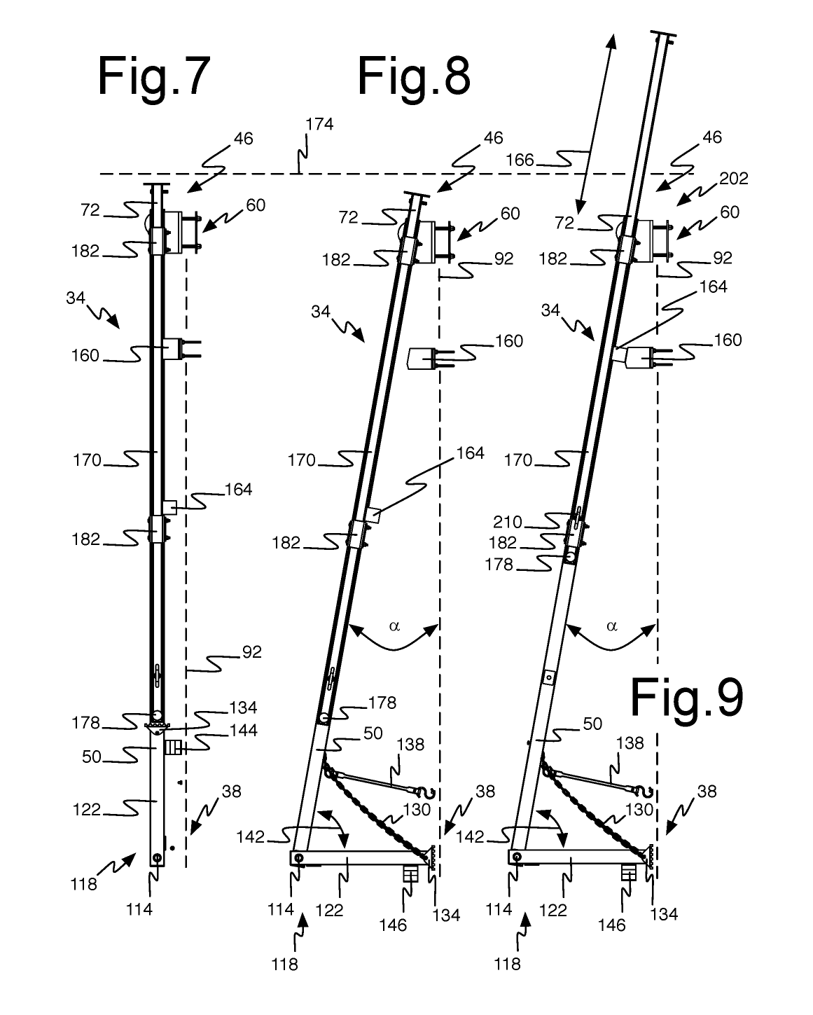

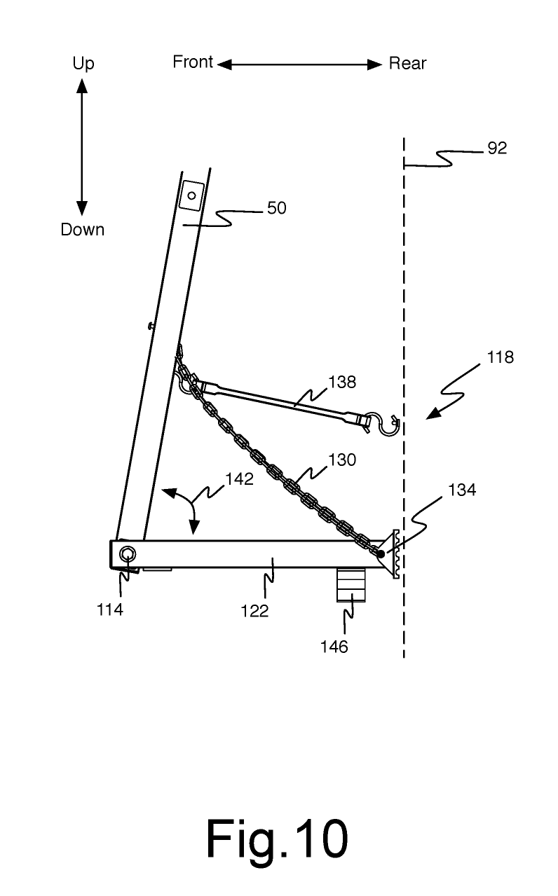

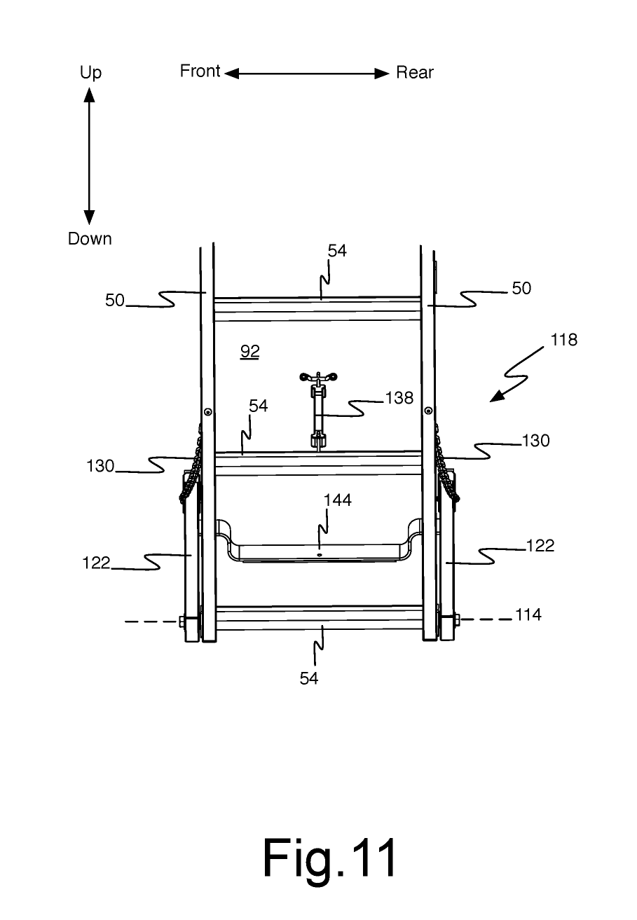

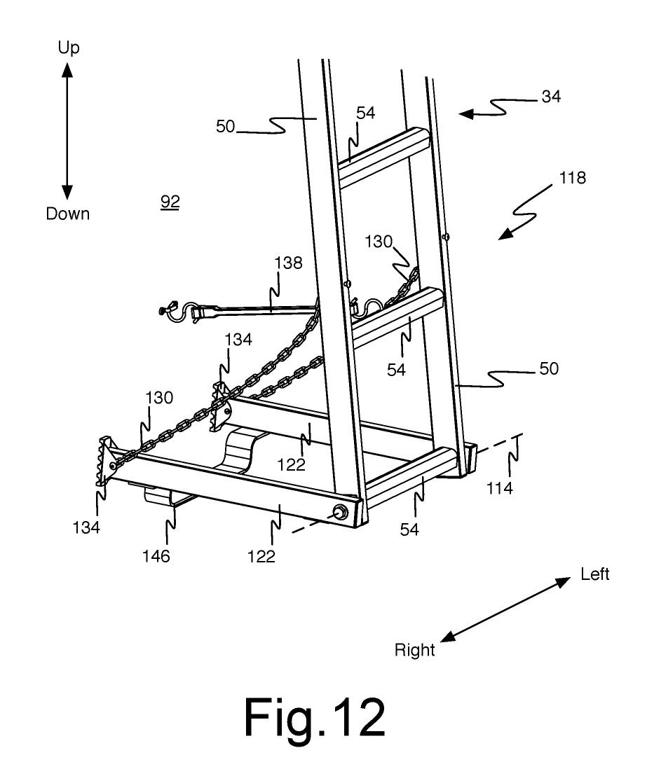

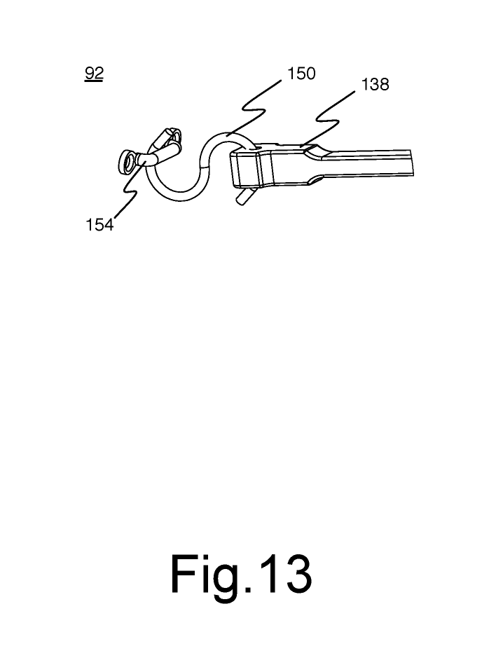

The climbing apparatus 30 is designed to move between a stored configuration 100, illustrated in FIG. 2, FIG. 3 and FIG. 7, and a work configuration 104, illustrated in FIG. 1, FIG. 4, FIG. 5, FIG. 6, FIG. 8 and FIG. 9. One can appreciate the stored configuration 100 position the climbing apparatus 30 generally vertically, adjacent to the trailer's wall 92, to use as little space as possible. In contrast, the work configuration 104 locates the ladder portion 34 at an angle a of about 80 degrees between the ladder portion 34 and support members 122, while the angle between the support members 122 and the trailer's wall 92 is of about 90 degrees, to ease its use by a user. Other suitable angles that are going to become obvious for a skilled reader in light of the present description are considered within the scope of the present invention. The low pivot portion 38 includes a low pivot 110 adapted to pivot a pivotable support 118 about a pivot axis 114. The pivotable support 118 is embodied in the figures with two support members 122 pivotally connected to a low portion 126 of each of the vertical members 50 of the ladder portion 34. The angular downward movement 142 of the support members 122 is limited by a retaining member 130, embodied by a chain in the figures. The distal ends of the support members 122 are provided by trailer-contacting portions 134 adapted to provide a strong contact with the trailer 10. The trailer-contacting portions 134 are preferably pivotable to adapt to the resulting angle with the trailer wall 92 and include a material, like rubber, that is not going to damage the trailer wall 92. Each support member 122 includes a secondary trailer-contacting portion 146 interconnecting the two support members 122 to ensure even and constant spacing thereof. The secondary trailer-contacting portion 146 is sized and designed to contact the trailer's wall 92 when the climbing apparatus in the stored configuration 100 and preferably maintains the ladder portion 34 parallel to the trailer's wall 92. An additional retaining mechanism 138 is used to pull back the lower portion of the ladder portion 34 toward the trailer's wall 92 to establish a good contact therewith. The additional retaining mechanism 138 is embodied as a bungie cord biasing the lower portion of the ladder portion 34 toward the trailer's wall 92. FIG. 13 is a magnified view of a possible mechanical connection between the additional retaining mechanism 138 and the trailer's wall 92. In this embodiment, the additional retaining mechanism 138 is connecting the trailer's wall 92 with a hook 150 and a hook-receiver 154 secured on the wall 92. Other mechanisms not described in the present description could be used to provide analogous functions without departing from the scope of the present application.

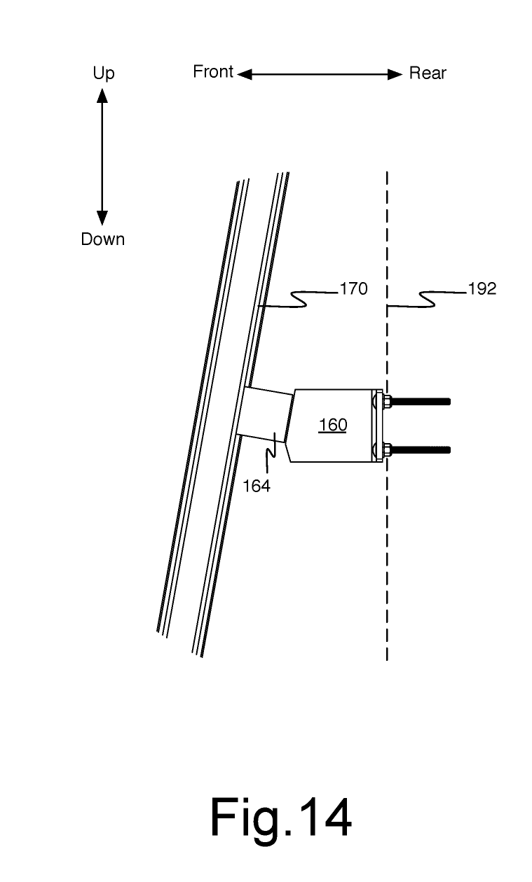

FIG. 14 illustrates a wall-securing bracket 160 adapted to further secure the ladder portion 34 to the trailer's wall 92. The wall-securing bracket 160 is used in conjunction with the extendable mechanism 46 discussed below. The wall-securing bracket 160 increases the stiffness of the assembly when the climbing apparatus 30 is in the work configuration 104 and prevents the extendable mechanism 46 to be in the expanded configuration when the climbing apparatus 30 is in the stored configuration 100. The wall-securing bracket 160 is embodied with a corresponding bracket contacting member 164 adapted to abut one onto the other to prevent the climbing apparatus to move from the work configuration 104 to the stored configuration 100 when the pole member 170 of extendable portion 46 is in its extended configuration.

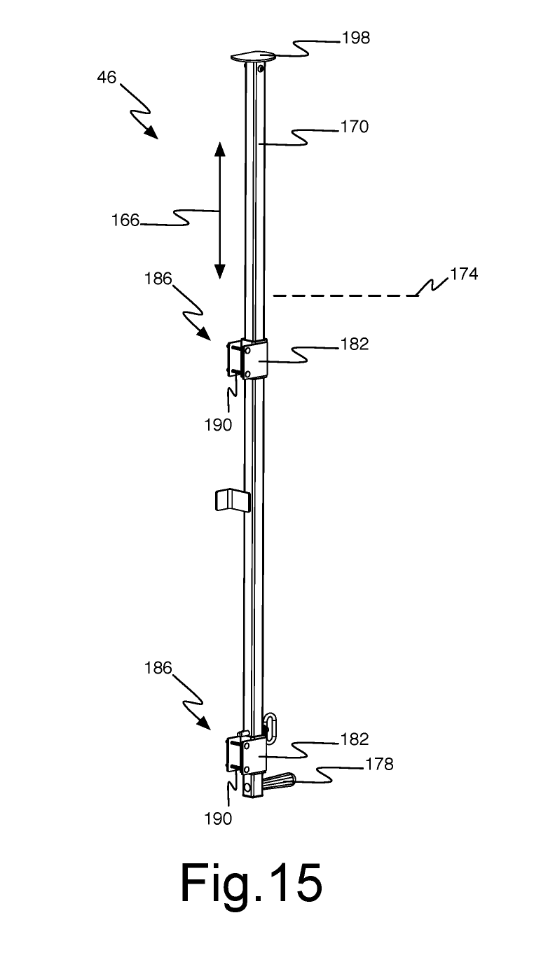

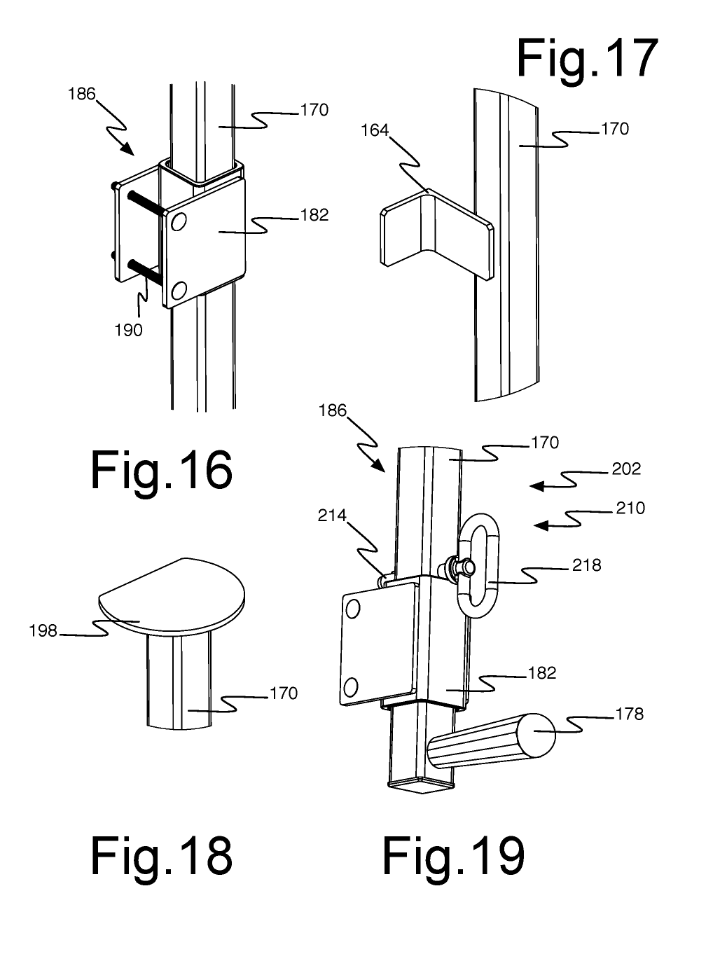

Moving now to FIG. 15 that is illustrating the extendable portion 46 of the climbing apparatus 30. The extendable portion 46 is a retractable mechanism for extending 166 a pole member 170 above the level of the trailer's roof 174 to offer a support to a user climbing on the trailer's roof. The user can hold the pole member 170 when moving on the trailer and getting down from the trailer's roof. The extendable portion 46 can be actuated form the bottom of the climbing apparatus 30 with a handle 178. The pole member 170 is slidably secured to the ladder portion 34 with a plurality of pole-receivers 182. The pole-receivers 182 are embodied in FIG. 15 with a mechanical securing mechanism 186 using fasteners 190 to connect the ladder portion 34. The fasteners 190 allow for an optional installation or a replacement of the extendable portion 46, if desired. The top end of the pole member 170 includes an end plate 198 to facilitate a good grip with a hand of a user climbing the climbing apparatus 30. An intermediate connecting bracket 164 is used to further secure the extendable portion 46 to the wall-securing bracket 166 when the pole member 170 is in the extended configuration 202, as illustrated in FIG. 9, and risking moving the trailer 10 with the pole member 170 extending above the trailer's roof level 174. The intermediate connecting bracket 164 abuts the wall-securing bracket 160 to add stiffness to the assembly and serves as a security device preventing moving back the climbing apparatus 30 to the stored configuration 100 when the pole member 170 is extending above the trailer's roof level 174. FIG. 18 is a magnified view of the pole member 170 and the end plate 198. FIG. 19 depicts the pole member 170 with its locking mechanism 210, embodied as a removable rod 214 equipped with a handle 218 for easy actuation. The locking mechanism 210 is removed from the pole member 170 and locked back in place above the lower pole-receiver 182 to keep the pole member extended as best seen in FIG. 1 and FIG. 9.

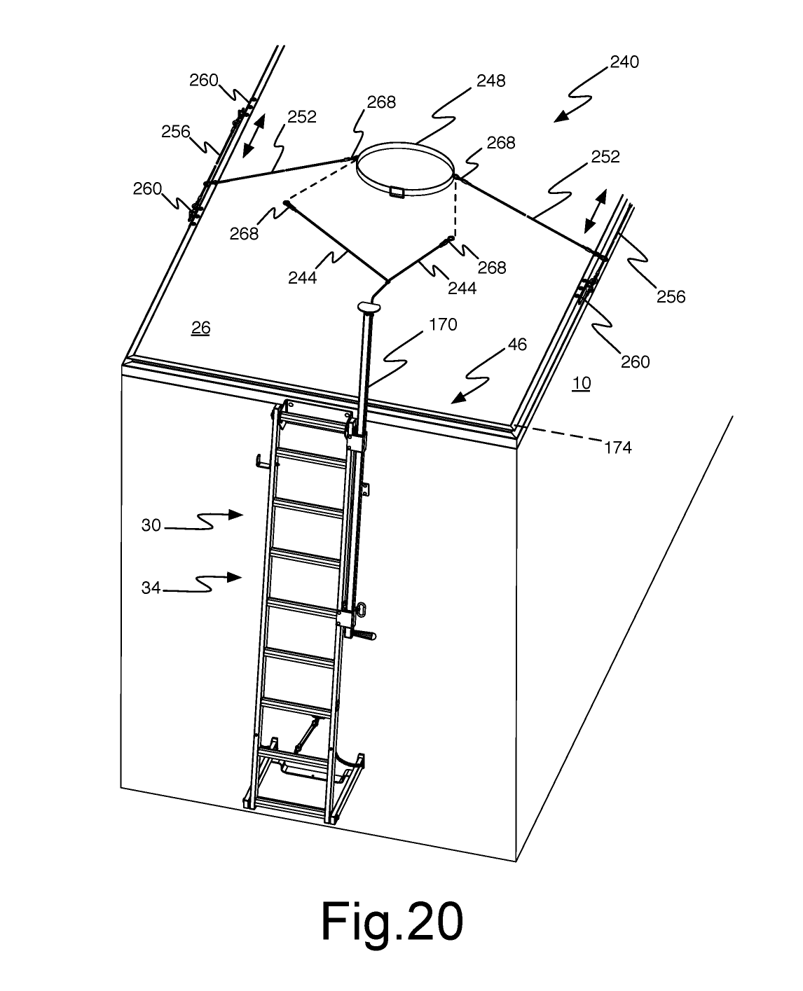

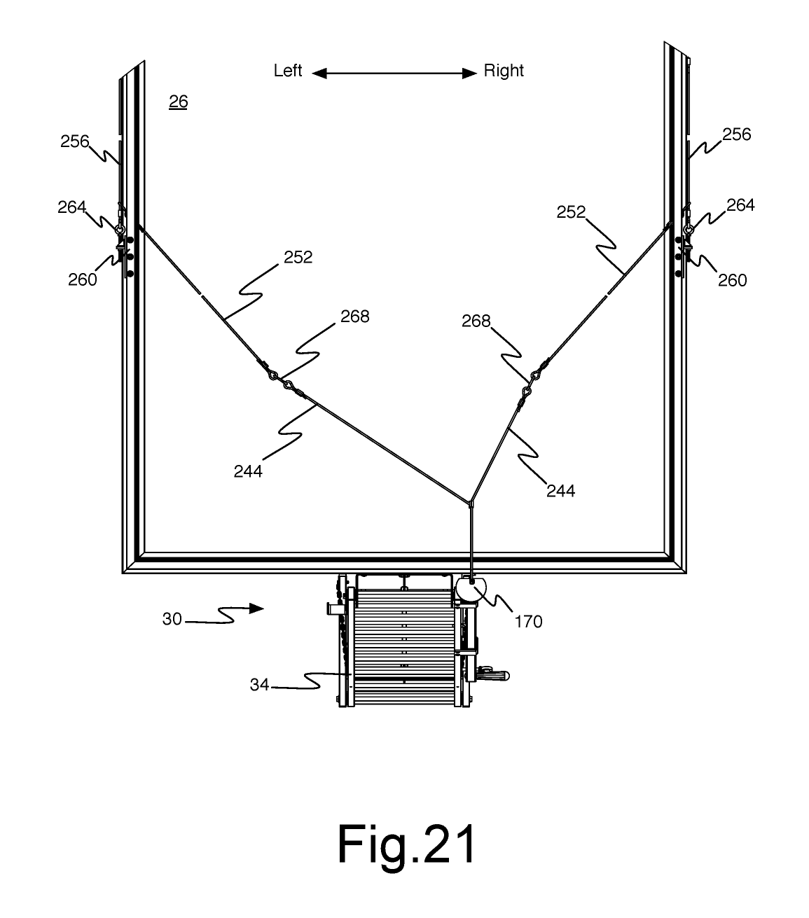

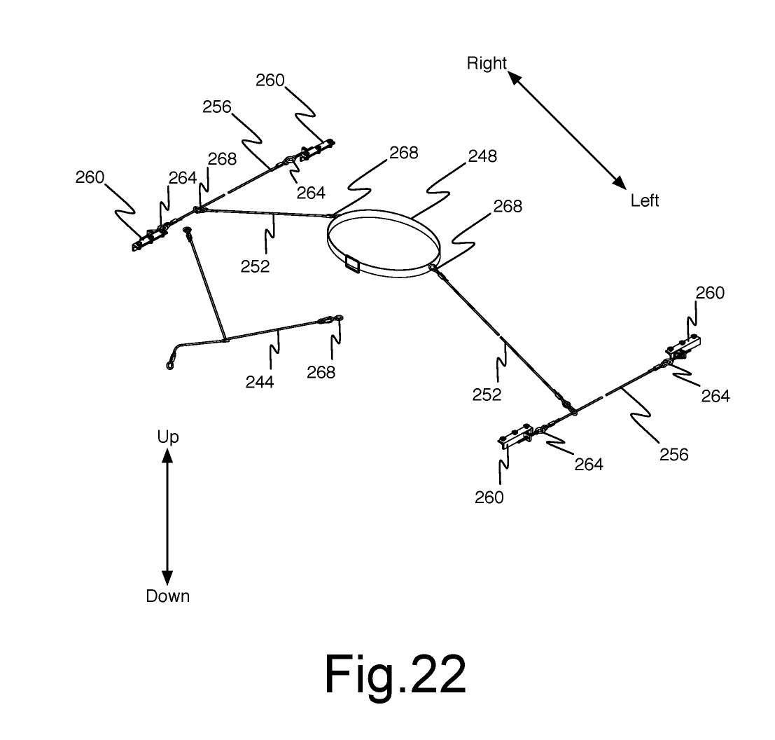

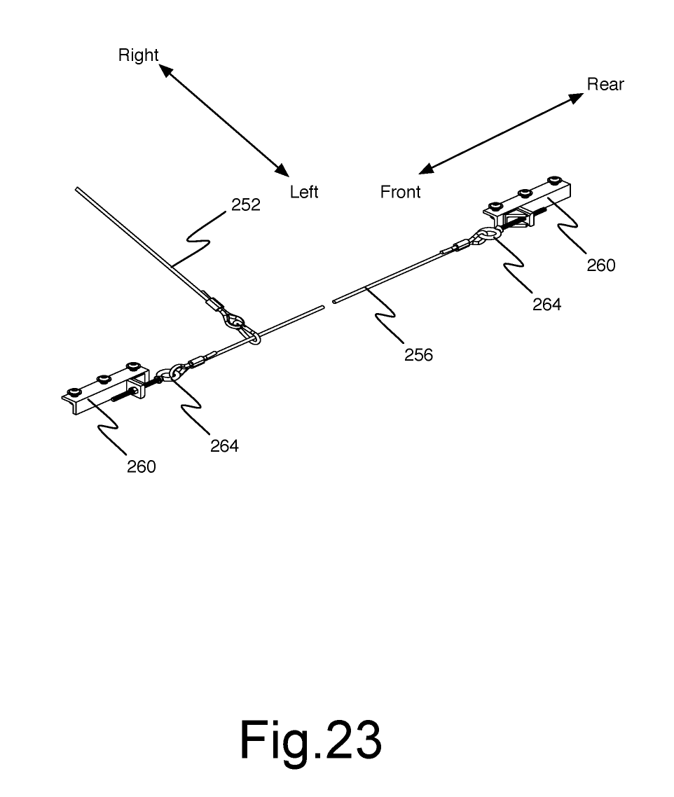

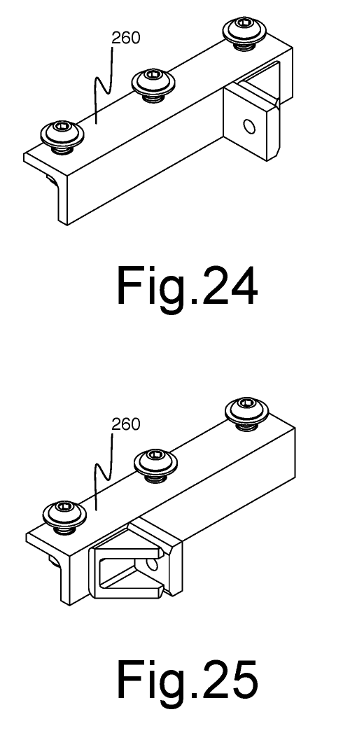

A user-retaining system 240 is illustrated in FIG. 20 and FIG. 21. The user-retaining system 240 is used to ensure the user is secured to the pole member 170 while transiting from the climbing apparatus 30 to the roof portion 26 of the trailer 10. A safety connection line 244 including two ends leading to the roof portion 26 is secured between the pole member 170 and a pair of transversal safety lines 252 when the climbing apparatus 30 is in the stored configuration 100. This allows an easy reach of the pair of transversal safety lines 252 when a user climbs the climbing apparatus 30 with the extendable portion 46 in the extended configuration 202. In one embodiment, one end of the safety connection line 244 is connected to the pole member 170 in a permanent way. The two other bifurcated ends of the pair of safety connection line 244 are each removably connected to the pair of transversal safety lines 252 for easy reach thereof. The user is wearing a harness 248 when climbing on the climbing apparatus 30 for securing the pair of transversal safety lines 252 thereto. The harness 248 is adapted to be secured to the pair of transversal safety lines 252 without being secured to the safety connection line 244 for allowing the user to move along the roof portion 26. The pair of transversal safety lines 252 are secured to a pair of longitudinal safety lines 256 adapted to slidably travel along the longitudinal length of the trailer 10. Extending up the pole member 170 of the extendable portion 46 gives the user improved access to removable securing clips 268 on the safety lines 252 for securing the harness 248. The length of the pair of transversal safety lines 252 is short enough to restrict movements of the user to prevent the harness 248, and the user secured therein, to move too close toward the side edges of the trailer's roof hence maintaining the user in a safe position near the middle of the trailer's roof to prevent any fall from the trailer's roof. The user, once secured to the pair of longitudinal safety lines 256 can move and work along the length of the trailer 10 to clean up any snow or ice while being secured on the top of the trailer 10. The configuration of the transversal safety lines 252 and the longitudinal safety lines 256 is made in a fashion preventing any fall of a user from the trailer's roof portion 26. The connection between the harness 248 and the safety lines 244, 252 can be made with fasteners such as those used with climbing equipment, or equivalent. The safety lines 244, 252, 256 can be made with steel wires, nylon ropes, composite materials wires or the like if their mechanical strength is proper.

The longitudinal safety lines 256 are secured to the trailer 10 with brackets 260 through tensioning elements 264 for tensing the longitudinal safety lines 256 properly.

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the spirit and scope of the appended claims. Furthermore, the dimensions of features of various components that may appear on the drawings are not meant to be limiting, and the size of the components therein can vary from the size that may be portrayed in the figures herein. Thus, it is intended that the present invention covers the modifications and variations of the invention, provided they come within the scope of the appended claims and their equivalents.

1. A climbing apparatus for climbing on a roof of a vehicle, the climbing apparatus comprising:
a ladder portion;
a single upper pivot portion for pivoting an upper portion of the ladder portion, the upper pivot portion being secured to a vehicle to allow movements of the ladder portion between a work configuration and a stored configuration next to a wall of the vehicle;
a movable support adapted to maintain the ladder portion in the work configuration by providing an increased angle between the ladder portion and the wall of the vehicle;
an extendable pole member slidably secured to a lateral side of the ladder portion, the extendable pole member being adapted to slide parallelly with the lateral side to extend above a roof level of the roof of the vehicle to provide a grasp above the roof level of the vehicle in the work configuration and to retract below the roof level in the stored configuration, the extendable pole member being directly connectable to a user-restraining system on the roof of the vehicle to secure a user moving between the ladder portion and the roof of the vehicle; and
a mechanism preventing the ladder portion to move to the stored configuration when the extendable pole member is extending above the roof level of the vehicle.

2. The climbing apparatus of claim 1, wherein the movable support is pivotally connected to a lower portion of the ladder portion.

3. The climbing apparatus of claim 2, wherein the movable support includes a pair of support members configured to generally orthogonally abutt the wall of the vehicle.

4. The climbing apparatus of claim 3, wherein the pair of support members includes pivotable vehicle-contacting portions to contact the wall of the vehicle.

5. The climbing apparatus of claim 1, wherein the mechanism preventing the ladder portion to move to the stored configuration when the extendable pole member is extending above the roof level of the vehicle includes a wall-securing bracket secured to the wall of the trailer and an associated bracket-contacting member secured to the extendable pole member that are interfering when the ladder portion is moving toward the stored configuration when the extendable pole member is extending above the roof level of the vehicle.

6. The climbing apparatus of claim 2, wherein the movable support is adapted to pivot substantially parallel with the ladder portion in the stored configuration.

7. The climbing apparatus of claim 1, wherein the extendable pole member is directly connected with a connection line to the user-restraining system affixed on the roof of the vehicle.

8. The climbing apparatus of claim 7, wherein the extendable pole member is operatively connected to the user-restraining system affixed on the roof of the vehicle, wherein the climbing apparatus is providing a continuous connection between the extendable pole member and the user-restraining system to continuously secure a user moving between the ladder portion and the roof of the vehicle.

9. The climbing apparatus of claim 8, wherein the user-retaining system includes at least one longitudinal safety line installed on the roof of the vehicle to allow longitudinal movement of the user on the roof of the vehicle.

10. The climbing apparatus of claim 9, wherein the user-retaining system includes at least one transverse safety line connected to the at least one longitudinal safety line to restrict movements of a user on the roof of the vehicle.

11. A vehicle including a climbing apparatus for climbing on a roof of the vehicle, the vehicle comprising:
a chassis;
a top portion joining a front portion, a right portion and a left portion connected to the chassis; and
a set of wheels supporting the chassis;
the climbing apparatus comprising:
a ladder portion;
a single upper pivot portion for pivoting the ladder portion, the upper pivot portion being secured to the vehicle to allow movements of the ladder portion between a work configuration and a stored configuration next to a wall of the vehicle;
a movable support adapted to maintain the ladder portion in the work configuration by providing an increased angle between the ladder portion and the wall of the vehicle;
an extendable pole member slidably secured to a lateral side of the ladder portion, the extendable pole member being adapted to slide parallelly with the lateral side to extend above a roof level of the roof of the vehicle to provide a grasp above the level of the roof of the vehicle in the work configuration and to retract at least at the level of the roof in the stored configuration, the extendable pole member being directly connectable to a user-restraining system on the roof of the vehicle to secure a user moving between the ladder portion and the roof of the vehicle; and
a mechanism preventing the ladder portion to move in the stored configuration when the extendable pole member is extending above the roof level of the vehicle.

12. The vehicle of claim 11, wherein the movable support is pivotally connected to a lower portion of the ladder portion.

13. The vehicle of claim 12, wherein the movable support includes a pair of support members configured to generally orthogonally abutt the wall of the vehicle.

14. The vehicle of claim 13, wherein the pair of support members includes pivotable trailer-contacting portions to contact the wall of the vehicle.

15. The vehicle of claim 11, wherein the mechanism preventing the ladder portion to move in the stored configuration when the extendable pole member is extending above the roof level of the vehicle includes a wall-securing bracket secured to the wall of the trailer and an associated bracket-contacting member secured to the extendable pole member that are interfering when the ladder portion is moving toward the stored configuration when the extendable pole member is extending above the roof level of the vehicle.

16. The vehicle of claim 12, wherein the movable support is adapted to pivot substantially parallel with the ladder portion into form the stored configuration.

17. The vehicle of claim 11, wherein the extendable pole member is directly connected with a connection line to the user-restraining system affixed on the roof of the vehicle.

18. The vehicle of claim 17, wherein the extendable pole member is operatively connected to the user-restraining system installed on the roof of the vehicle is providing a continuous connection between the extendable pole member and the user-restraining system.

19. The vehicle of claim 18, wherein the user-retaining system includes at least one longitudinal safety line disposed on the vehicle to allow longitudinal movement of a user on the roof of the vehicle.

20. The vehicle of claim 19, wherein the user-retaining system includes at least one transverse safety line connectable to the at least one longitudinal safety line to restrict movements of a user on the roof of the vehicle.
